(19) United States
(12) Patent Application Publication
(10) Pub. No.: US 2007/0153547 A1
(43) Pub. Date: Jul. 5, 2007

(54) LIGHT SOURCE MODULE AND OPTICAL PROJECTION APPARATUS

(75) Inventor: Chin-Ku Liu, Miao-Li County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/561,897

(22) Filed: Nov. 21, 2006

(30) Foreign Application Priority Data
Jan. 3, 2006 (TW) 95100157

(51) Int. Cl. F21V 7/04

(52) U.S. Cl. 362/613

(57) ABSTRACT

A light source module includes a first and a second light source sets, and a light guide element (LGE) having a light exit end, a light incident end, and reflection planes connected between thereof. A first and a second filter films are disposed between the edge of the light exit end and the light incident end of the LGE. The internal space of the LGE is divided by the filter films into a first, a second, and a third wedge regions. The first and second light source sets are disposed at the light incident ends correspond to the first and second wedge regions respectively. Light beams from the first light source set and the second source set pass through the first filter film and the second filter respectively, and then to be reflected by the second filter film and first filter film respectively.

### CROSS-REFERENCE TO RELATED APPLICATION

This application claims the priority benefit of Taiwan application serial no. 95100157, filed Jan. 3, 2006. All disclosure of the Taiwan application is incorporated herein by reference.

### BACKGROUND OF THE INVENTION

1. Field of Invention

The present invention relates to a light source module, and particularly to a light source module of an optical projection apparatus.

2. Description of the Related Art

Referring to FIG. 1A and FIG. 1B, a conventional optical projection apparatus 100 includes an illumination system 110, a projection lens 120 and a digital micro-mirror device (DMD) 130. The DMD 130 is disposed between the illumination system 110 and the projection lens 120. Besides, the illumination system 110 includes a light source set 112, a light integration rod 114 and a lens 116. The light integration rod 114 is disposed between the light source set 112 and the DMD 130, and the lens 116 is disposed between the light integration rod 114 and the DMD 130.

The light source set 112 is suitable for providing a light beam 113, which passes through the light integration rod 114 and the lens 116, then arrives at the DMD 130, where the DMD 130 converts the light beam 113 into an image beam 113′. The projection lens 120 makes the image beam 113′ projected onto a screen (not shown) to produce images.

In the above-described optical projection apparatus 100, limited by the etendue of the DMD 130, the light source set 112 is formed by four LEDs (light-emitting diodes) only, which usually are a red LED R, a blue LED B and two green LEDs G. In an optical projection apparatus with a DMD, however, the LEDs of the light source set thereof sequentially lighten in turn to produce red light, green light and blue light. Due to the insufficient light-emitting luminance of a single LED, the brightness of the images projected from the projection lens 120 is relatively lower.

Referring to FIGS. 2A and 2B, another conventional optical projection apparatus 100a is similar to the above-described optical projection apparatus 100, except that the illumination system 110a of the optical projection apparatus 100a employs two light source sets 112a and 112b to advance the image luminance. The light source set 112a is disposed at the light incident end of a light integration rod 114a, the light source set 112b is disposed at the light incident end of a light integration rod 114b and a filter 118 is disposed between the light integration rod 114a and the light integration rod 114b for the light beam 113a emitted from the light source set 112a to pass it and reflect the light beam 113b emitted from the light source set 112b.

The above-described light source set 112a is formed by two red LEDs R and two blue LEDs B and the light source set 112b is formed by four green LEDs G. Herein, since the optical projection apparatus 100a has two light source sets 112a and 112b, the image luminance is effectively improved. However, the optical projection apparatus 110a occupies a larger space, which makes the optical projection apparatus 110a more bulky that does not meet the prevalent trend of the light, slim, short, small electronic products.

### SUMMARY OF THE INVENTION

The present invention is related to a light source module with a down-sized structure and an increased light-emitting luminance.

The present invention is further related to an optical projection apparatus with a down-sized structure and an increased light-emitting luminance.

To achieve the above-described or other objects, the present invention provides a light source module, which includes a light guide element (LGE), a first light source set and a second light source set. The LGE has a light exit end, a light incident end and a plurality of reflection planes connected between the light exit end and the light incident end. In addition, A first filter film and a second filter film are disposed between the edge of the light exit end and the light incident end of the LGE, and the internal space of the LGE is divided by the filter films into a first wedge region between the first filter film and the light incident end, a second wedge region between the second filter film and the light incident end, and a third wedge region between the first filter film and the second filter film. The first light source set is disposed at the light incident end of the LGE and corresponds to the first wedge region, and the second light source set is disposed at the light incident end of the LGE and corresponds to the second wedge region. The first filter film is suitable for a light beam emitted from the first light source set to pass through and reflect a light beam emitted from the second light source set, the second filter film is suitable for the light beam emitted from the second light source set to pass through and reflect the light beam emitted from the first light source set.

The present invention further provides another light source module, which includes a light guide element (LGE) and a plurality of light source sets. The LGE has a light exit end, a light incident end and a plurality of reflection planes connected between the light exit end and the light incident end. A plurality of filter films is disposed between the edge of the light exit end and the light incident end of the LGE, and the internal space of the LGE is divided by the filter films into a plurality of taper regions and a common region located between the taper regions. Besides, the light source sets are disposed at the light incident end of the LGE and correspond to the taper regions. Each filter film corresponding to the light source set is suitable for a light beam emitted from a corresponding light source set to pass through and reflect light beams emitted from the other color light source sets.

The present invention further provides an optical projection apparatus, which includes a light guide element (LGE), a plurality of light source sets, a digital micro-mirror device (DMD) and a projection lens. The LGE has a light exit end, a light incident end and a plurality of reflection planes connected between the light exit end and the light incident end. A plurality of filter films is disposed between the edge of the light exit end and the light incident end of the LGE, and the internal space of the LGE is divided into a plurality of taper regions and a common region located between the taper regions. The light source sets are disposed at the light incident end of the LGE and correspond to the taper regions, each filter film corresponding to a light source set is suitable for a light beam emitted from a corresponding light source set to pass through and reflect light beams emitted from the other light source sets, and then the light beam emitted from the corresponding light source set is emitted out of the LGE from the light exit end. Besides, the DMD is disposed on an optical path of the light beam to convert the light beam into an image light beam. The projection lens is disposed on an optical path of the image light beam, so as to project an image onto a screen.

Since a plurality of light source sets are employed, the light source module of the present invention can increase light-emitting luminance. In addition, since the light source sets are disposed at the light incident end of the LGE, in comparison with the conventional configuration employing two light source sets, the light source module of the present invention has down-sized advantage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a diagram of a conventional optical projection apparatus with LEDs as a light source.

FIG. 1B is a diagram of a light source set in FIG. 1A.

FIG. 2A is a diagram of another conventional optical projection apparatus with LEDs as a light source.

FIG. 2B is a diagram of two light source sets in FIG. 2A.

FIG. 3A is a perspective view of a light source module according to a first embodiment of the present invention.

FIG. 3B is a top view of the light source module in FIG. 3A.

FIG. 4 is a diagram of a first light source set and a second light source set according to the first embodiment of the present invention.

FIG. 5A is an optical path diagram of light beams emitted from the first light source set according to the present invention.

FIG. 5B is an optical path diagram of light beams emitted from the second light source set according to the present invention.

FIG. 6 is a diagram showing a formation of the light guide element (LGE) according to the first embodiment of the present invention.

FIG. 7 is a diagram showing another formation of the light guide element (LGE) according to the first embodiment of the present invention.

FIG. 8 is a schematic perspective view of a light source module according to a second embodiment of the present invention.

FIG. 9A is a top view of the light source module in FIG. 8.

FIG. 9B is a side view of the light source module in FIG. 8.

FIG. 10 is a diagram of a plurality of light source sets in the second embodiment according to the present invention.

FIG. 11A and FIG. 11B are diagrams showing a formation of the light guide element (LGE) according to the second embodiment of the present invention.

FIG. 12 is a structure diagram of an optical projection apparatus according to the second embodiment of the present invention.

### DESCRIPTION OF THE EMBODIMENTS

### The First Embodiment

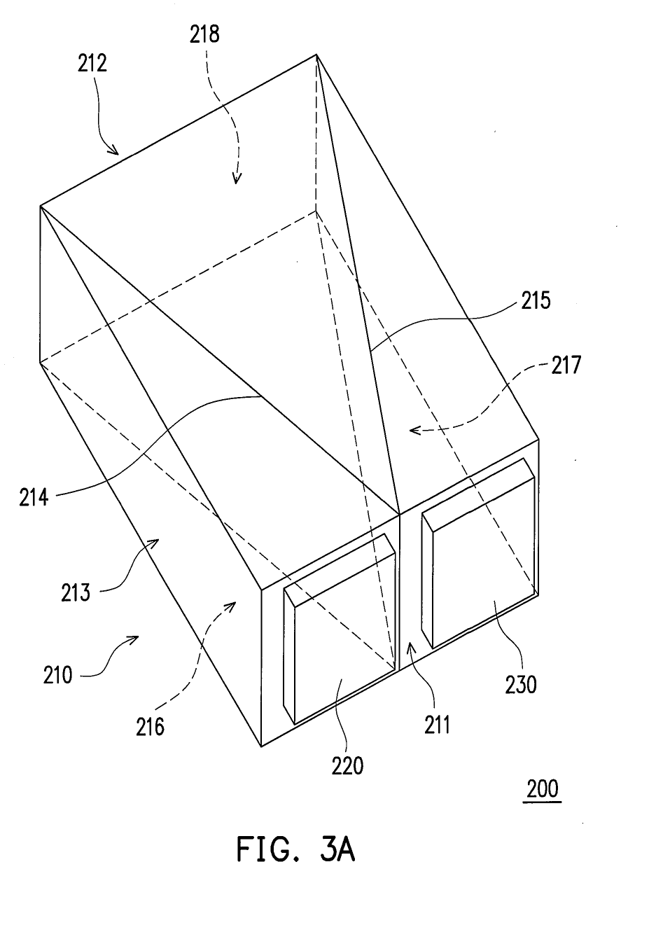

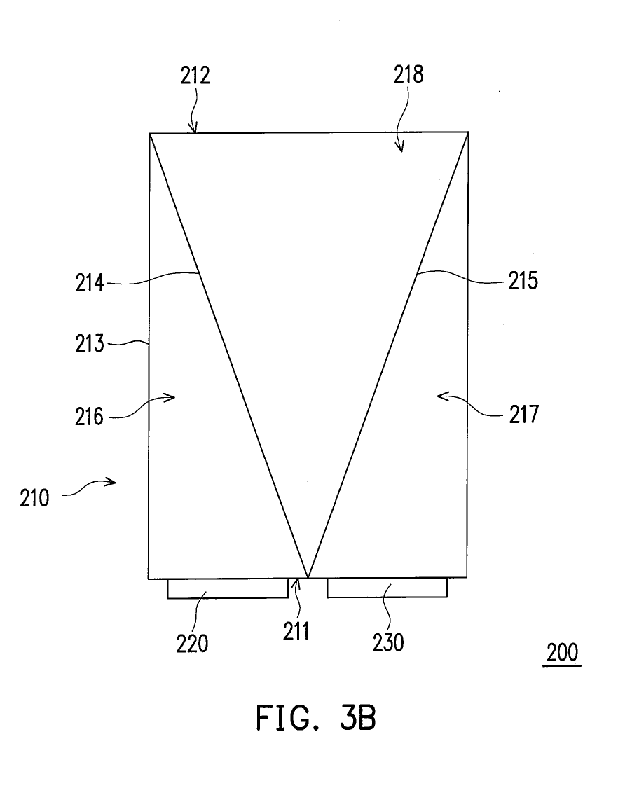

Referring to FIGS. 3A and 3B, a light source module 200 according to a first embodiment of the present invention is suitable for disposing in an optical projection apparatus to serve as a light source. The light source module 200 includes a light guide element (LGE) 210, a first light source set 220 and a second light source set 230. Wherein, the LGE 210 has a light incident end 211, a light exit end 212 and a plurality of reflection planes 213 connected between the light exit end 212 and the light incident end 211. A first filter film 214 and a second filter film 215 are disposed between the edge of the light exit end 212 and the light incident end 211 of the LGE, and thus the internal space of the LGE 210 is divided into a first wedge region 216 between the first filter film 214 and the light incident end 211, a second wedge region 217 between the second filter film 215 and the light incident end 211, and a third wedge region 218 between the first filter film 214, the second filter film 215, and the light exit end 212. The first light source set 220 is disposed at the light incident end 211 of the LGE 210 and corresponds to the first wedge region 216. The second light source set 230 is disposed at the light incident end 211 of the LGE 210 and corresponds to the second wedge region 217. The first filter film 214 is suitable for a light beam emitted from the first light source set 220 to pass through and reflect a light beam emitted from the second light source set 230, the second filter film 215 is suitable for the light beam emitted from the second light source set 230 to pass through and reflect the light beam emitted from the first light source set 220.

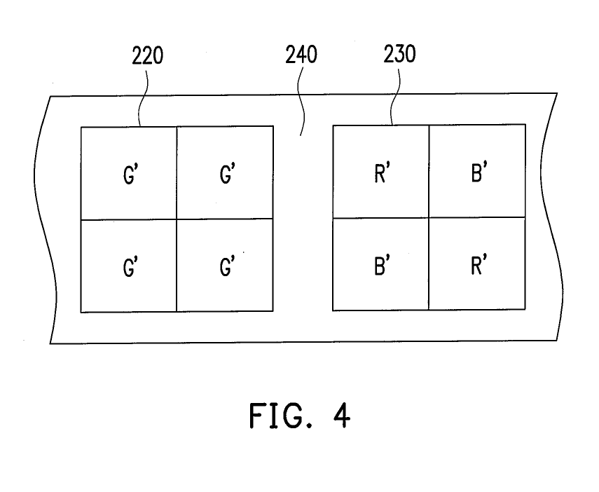

Referring to FIG. 4, the first light source set 220 and the second light source set 230 in the light source module 200 are disposed on, for example, a circuit board 240. The first light source set 220 includes a plurality of first color light sources, for example, green light sources G′. The second light source set 230 includes a plurality of second color light sources, for example, blue light sources B′ and a plurality of third color light sources, for example, red light sources R′. In the embodiment, the above-described color light sources are, for example, LEDs.

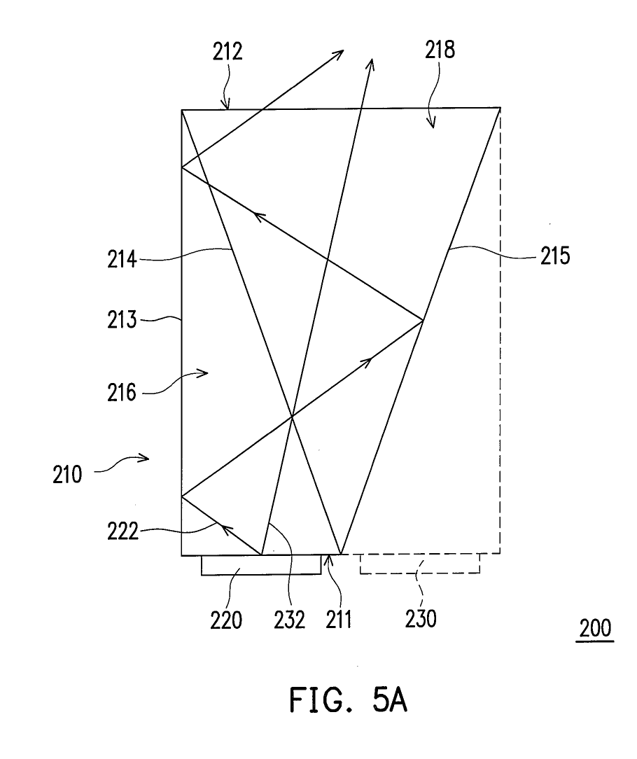

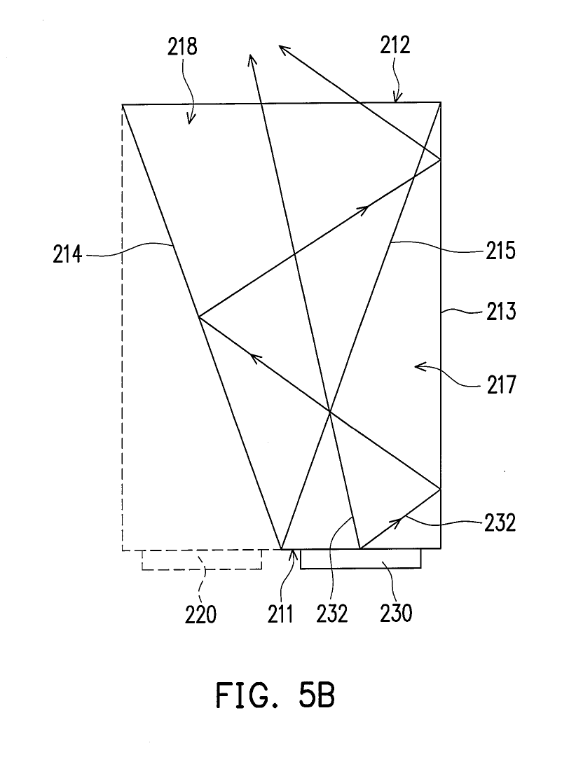

Referring to FIG. 5A, in the embodiment the green light source G′, the blue light source B′ and the red light source R′ lighten in turn according to the optical projection apparatus requirement. As the green light source G′ is lightened (i.e. the first light source set 220 lightens), the first filter film 214 makes the light beam 222 emitted from the first light source set 220 pass through, and the second filter film 215 reflects the light 222. Thus, after the partial light beam 222 is incident into the LGE 210 from the light incident end 211, an incident light beam is reflected between the second filter film 215 and the reflection planes 213 surrounding the first wedge region 216 and the third wedge region 218. In other words, as the first light source set 220 is lightened, the LGE 210 functions as a light integration rod formed by the second filter film 215 and the reflection planes 213 surrounding the first wedge region 216 and the third wedge region 218.

Referring to FIG. 5B, as the blue light source B′ or the red light source R′ is lightened (i.e. the second light source set 230 lightens), the second filter film 215 makes the light beam 232 emitted from the second light source set 230 pass through, and the first filter film 214 reflects the light beam 232. Thus, after the partial light beam 232 is incident into the LGE 210 from the light incident end 211, an incident light beam is reflected between the first filter film 214 and the reflection planes 213 surrounding the second wedge region 217 and the third wedge region 218. Finally, the light beam is emitted out of the LGE from the light exit end 212. In other words, as the second light source set 230 is lightened, the LGE 210 functions as a light integration rod, which is formed by the first filter film 214 and the reflection planes 213 surrounding the second wedge region 217 and the third wedge region 218.

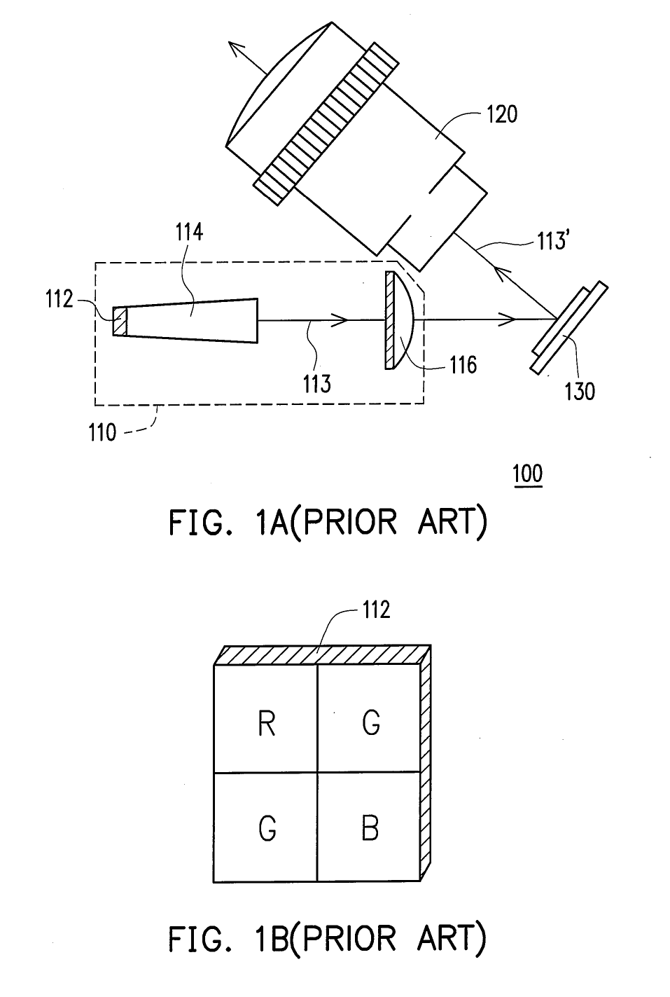

The following table depicts the comparison data of image luminance on a screen produced by the conventional optical projection apparatus 100 (as shown in FIG. 1A) and the optical projection apparatus with the light source module 200 provided by the embodiment. The data in the table are obtained according to a simulation of a hundred thousands of light beams, and the result is considered as exemplary and no to limit the present invention. Each light source set is formed by four LEDs with 1 mm×1 mm cross-section size, and both the conventional light integration rod 114 (as shown in FIG. 1A) and the LGE 210 (as shown in FIG. 3A) have the same length, 30 cm, and the same size of light exit end thereof.

| | | Total output image | |
|---|---|---|---|
| | Number of | luminance of the light | Image |
| | light source | sources | luminance |
| | set | (lumen) | (lumen) |
| The prior art | 1 | 125 | 67.4237 |
| The present | 2 | 250 | 118.5764 |
| invention | | | |

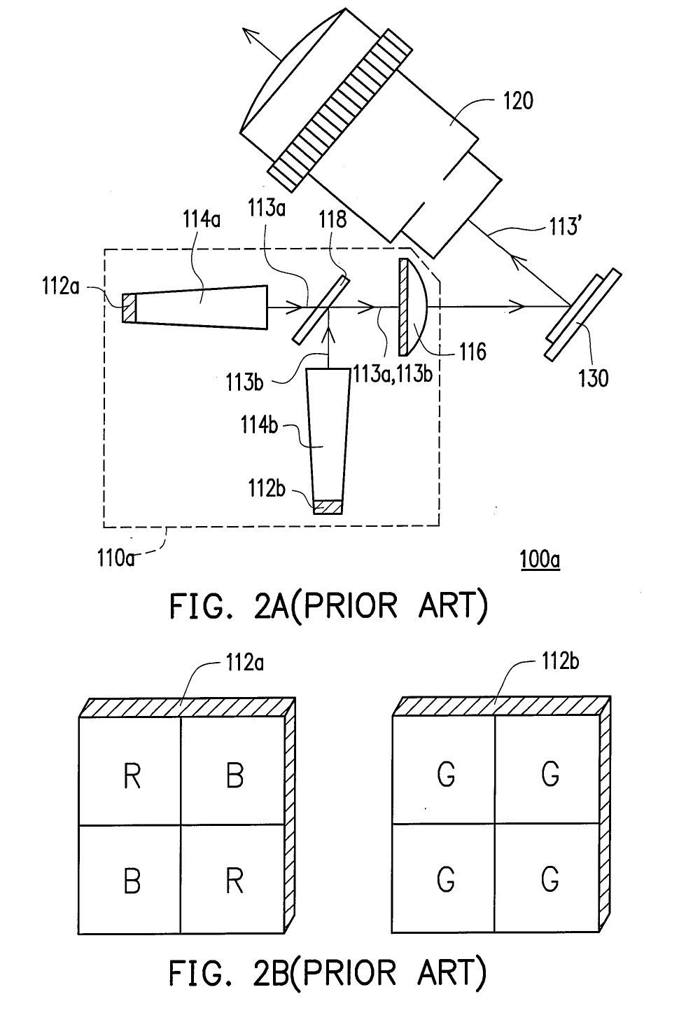

It can be seen in the table that counting the image luminance on the screen projected by the conventional optical projection apparatus 100 as 100%, the equivalent image luminance corresponding to the optical projection apparatus with the light source module 200 of the present invention is 175.9%. Although the volume of the LGE 210 is slightly larger than the volume of the conventional light integration rod, however, in comparison with the prior art where two light source sets are employed (as shown in FIG. 2A), on the whole, the light source module 200 of the present invention has a smaller and compact structure. In other words, the light source module 200 according to the present invention used in an optical projection apparatus increases the image luminance without adding the volume of the whole optical projection apparatus.

The LGE 210 of the embodiment also can be formed by different ways. Two examples are given to explain how to form an LGE 210. Nevertheless, the present invention does not limit the formation of the LGE 210.

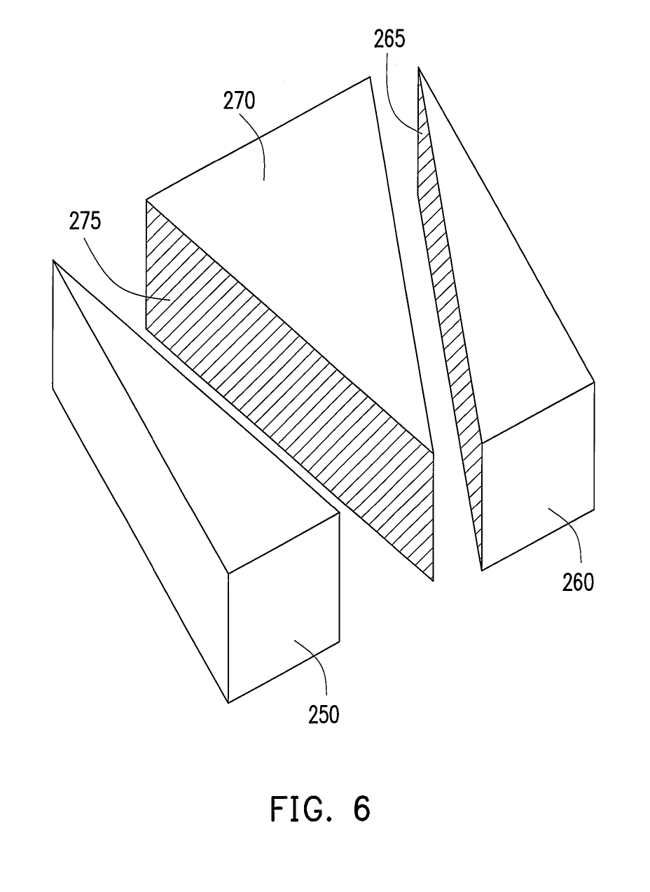

FIG. 6 is a diagram showing a formation of the LGE 210 according to the first embodiment of the present invention. Referring to FIG. 3B and FIG. 6, the LGE 210 in the embodiment is formed by a first prism 250, a second prism 260 and a third prism 270, which are corresponding to the first wedge region 216, the second wedge region 217 and the third wedge region 218, respectively, so as to provide the first filter film 214, the second filter film 215 and a plurality of the reflection planes 213. The first filter film 214 is a coating layer 275 disposed on the joint interface of the first prism 250 and the third prism 270, and the second filter film 215 is a coating layer 265 disposed on the joint interface of the second prism 260 and the third prism 270. The reflection planes 213 are, for example, total reflection planes of the first prism 250, the second prism 260, and the third prism 270.

The production cost of LGEs is saved by the ripe manufacturing technologies of prism cutting and film coating today. Note that although the coating layer 275 is made on the third prism 270 as shown in FIG. 6, the coating layer 275 can be made on the first prism 250 too. Similarly, although the coating layer 265 is made on the second prism 260 as shown in FIG. 6, the coating layer 265 can be made on the third prism 270.

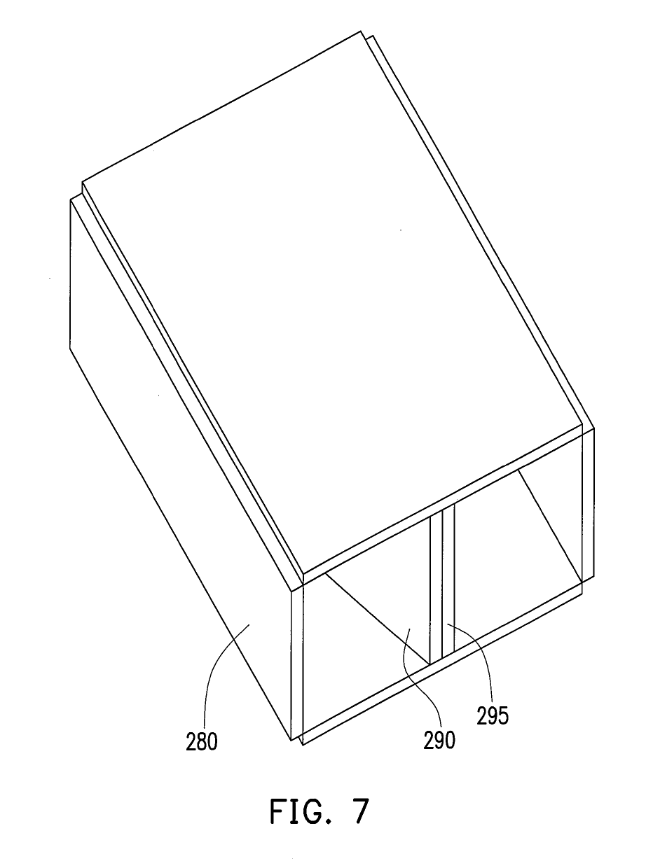

FIG. 7 is a diagram showing another formation of the light guide element (LGE) according to the first embodiment of the present invention. Referring to FIG. 3B and FIG. 7, the LGE 210 in the embodiment is formed by a plurality of reflection mirrors 280, a first filter plate 290, a second filter plate 295. The reflection mirrors 280 are used for providing reflection planes 213, and the first filter plate 290 and the second filter plate 295 are served as the first filter film 214 and the second filter film 215, respectively. Comparing with the light integration rod 114 of the conventional optical projection apparatus 100, the LGE 210 in the FIG. 7 is simpler and the production cost thereof is lower too. In addition, the forming structure further benefits by avoiding the prisms from absorbing light.

### The Second Embodiment

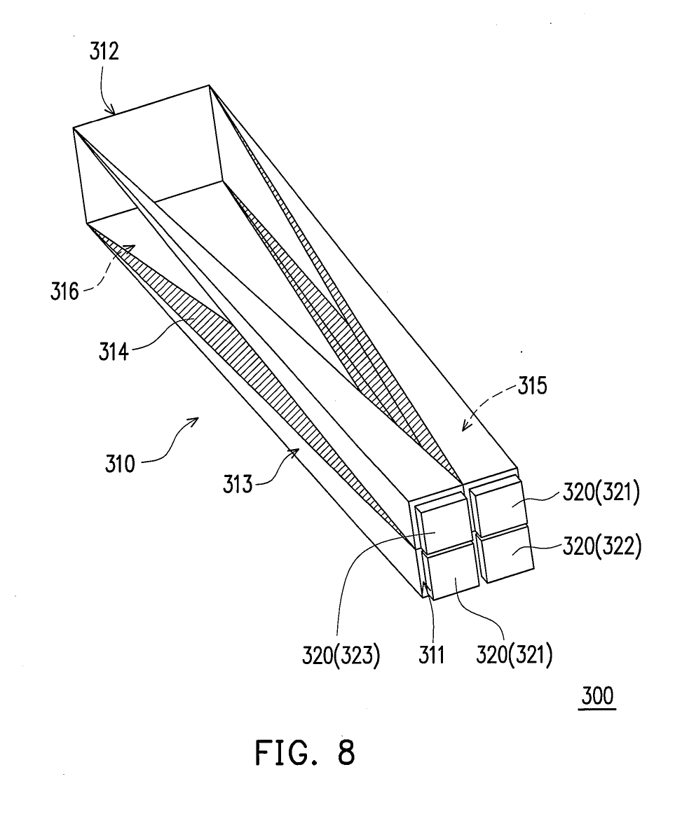

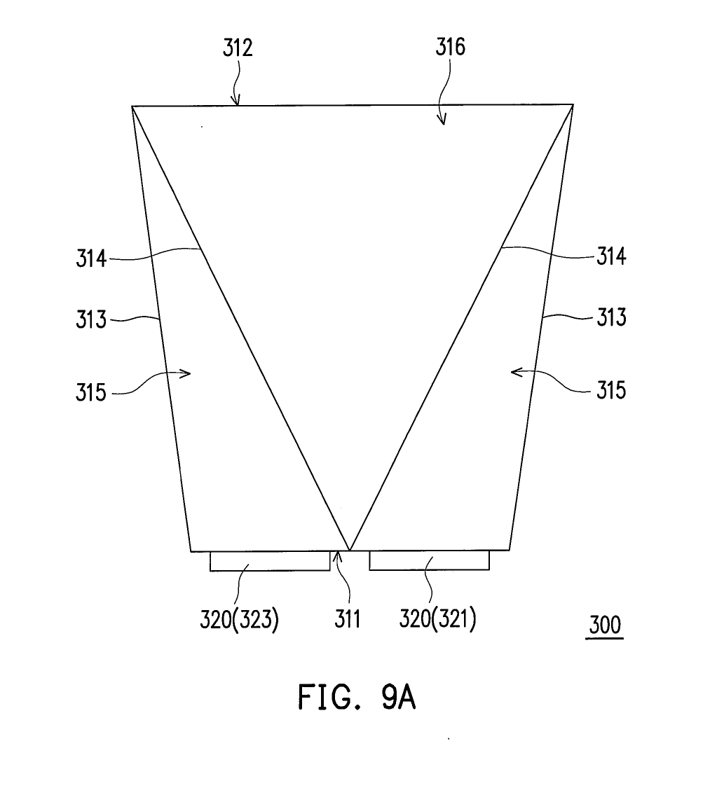

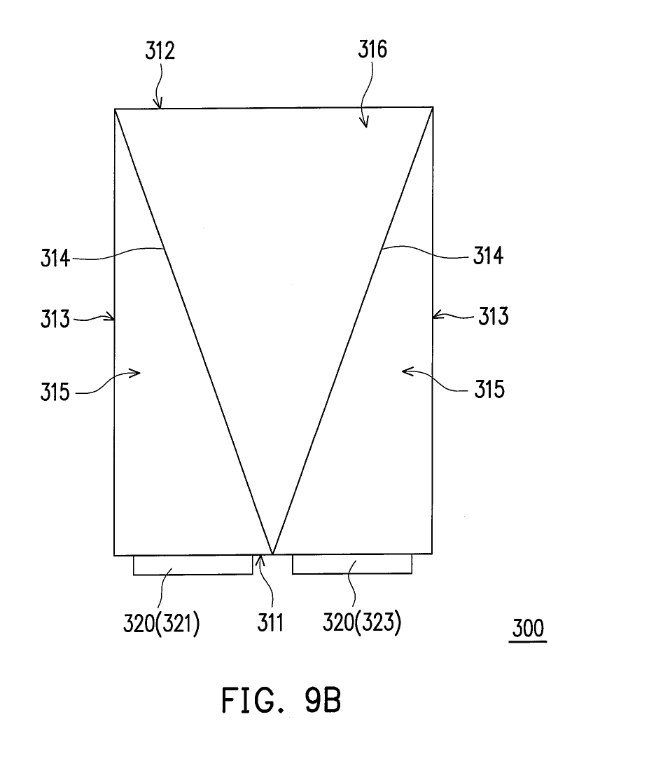

Referring to FIGS. 8, 9A and 9B, the light source module 300 of the embodiment includes a light guide element (LGE) 310 and a plurality of light source sets 320. The LGE 310 has a light incident end 311, a light exit end 312 and a plurality of reflection planes 313 connected between the light exit end 312 and the light incident end 311. A plurality of filter fins 314 is disposed between the edge of the light exit end 312 and the light incident end 311 of the LGE, so as to divide the inner space of the LGE 310 into a plurality of taper regions 315 and a common region 316 located between the taper regions 315. Besides, each filter film 314 corresponding to a light source set 330 is suitable for a light beam emitted from the light source set 330 to pass through and reflect light beams emitted from the other different color light source sets 320.

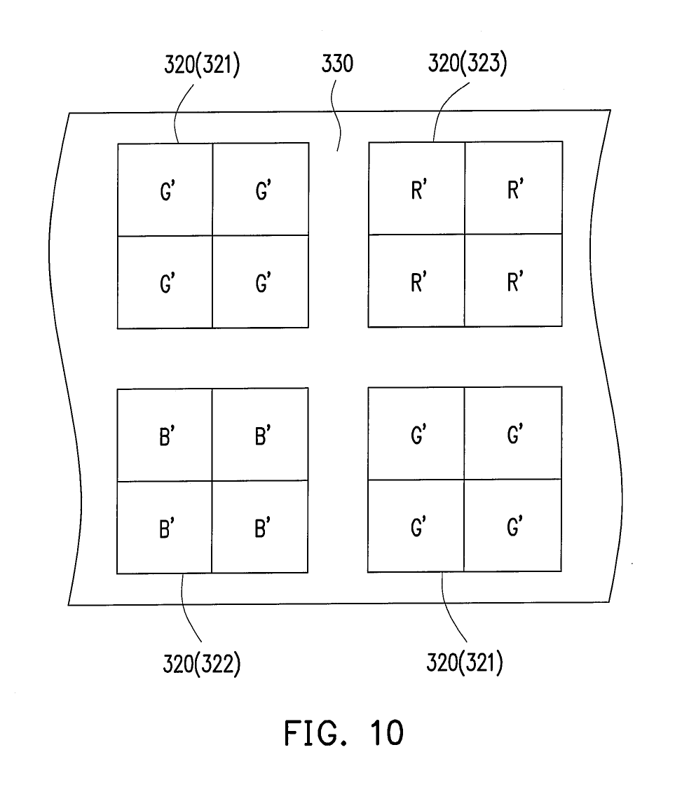

Referring to FIG. 10, each of the light source sets 320 in the light source module 300 is disposed on, for example, a circuit board 330. The light source sets 320 is categorized into a first color light source set 321, a second color light source set 322 and a third color light source set 323. In the embodiment, there are two first color light source sets 321 in total and each of them includes a plurality of first color light sources, for example, green light sources G′. The second color light source set 322 is singular one and includes a plurality of second color light sources, for example, blue light sources B′. The third color light source set 323 is singular one too and includes a plurality of third color light sources, for example, red light sources R′. In addition, the above-described color light sources are, for example, LEDs.

In the embodiment, the green light source G′, the blue light source B′ and the red light source R′ lighten in turn according to the requirement of the optical projection apparatus. As the green light source G′ is lightened, the filter film 314 corresponding to the first color light source set 321 makes the green light beam pass through, and the other filter films 314 reflect the green light beam. Thus, after the partial green light beam is incident into the LGE 310 from the light incident end 311, the incident light beam is reflected between the reflection planes 313 surrounding the taper region 315 corresponding to the first color light source set 321, the reflection planes 313 surrounding the common region 316 and the filter film 314 able to reflect the green light beam. Finally, the green light beam is emitted out of the LGE 310 from the light exit end 312.

Similarly, as the blue light source B′ is lightened and after the partial blue light beam is incident into the LGE 310 from the light incident end 311, the incident light beam is reflected between the reflection planes 313 surrounding the taper region 315 corresponding to the second color light source set 322, the reflection planes 313 surrounding the common region 316 and the filter film 314 able to reflect the blue light beam; finally, the blue light beam is emitted out of the LGE 310 from the light exit end 312. As the red light source R′ is lightened and after the partial red light beam is incident into the LGE 310 from the light incident end 311, the incident light beam is reflected between the reflection planes 313 surrounding the taper region 315 corresponding to the third color light source set 323, the reflection planes 313 surrounding the common region 316 and the filter film 314 able to reflect the red light beam; finally, the red light beam is emitted out of the LGE 310 from the light exit end 312.

Since the light source module 300 of the embodiment employs four light source sets 320, the light source module 300 of the present invention has increased light-emitting luminance. Consequently, an optical projection apparatus uses the light source module 300 can largely advance the projected image luminance thereof. In addition, in comparison with the conventional configuration employing two light source sets, the light source module 300 of the present embodiment obviously has down-sized advantage.

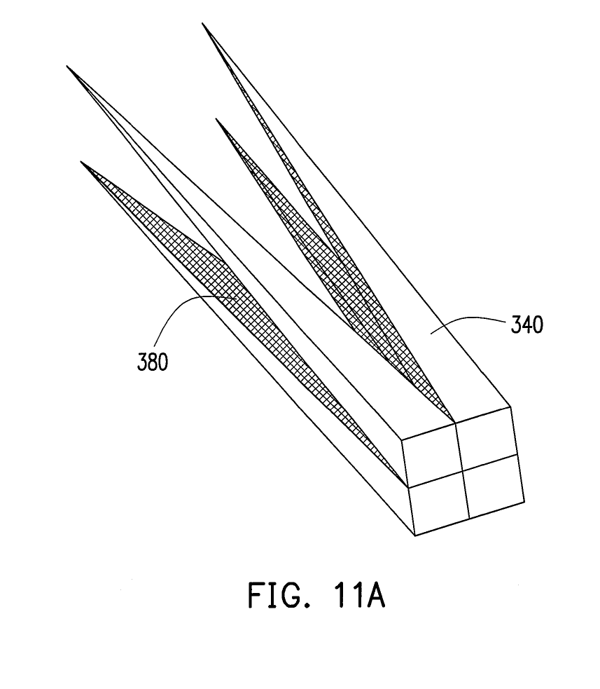

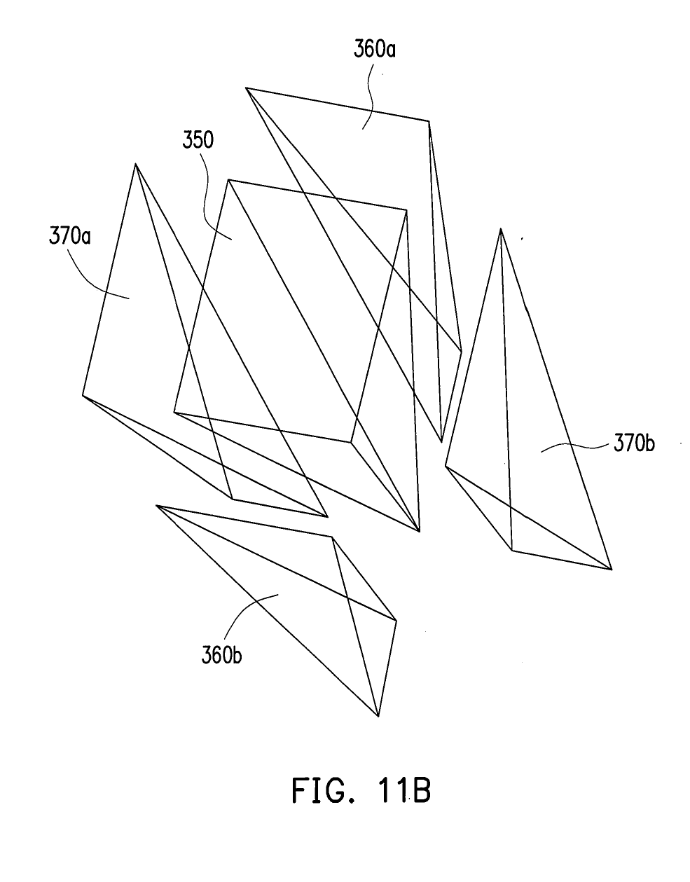

FIG. 11A and FIG. 11B are diagrams showing a formation of the light guide element (LGE) according to the second embodiment of the present invention. Referring to FIGS. 8, 11A and 11B, the LGE 310 in the embodiment is formed by a plurality of prisms 340 corresponding to the taper region 315 and the prisms corresponding to the common region 316 for providing the above-described filter films 314 and the reflection planes 313. The common region 310 corresponds to a plurality of prisms. For example, the prisms corresponding to the common region 315 are formed by, for example, a prism 350, prisms 360a and 360b joining the upper surface and the lower surface of the prism 350, and prisms 370a and 370b joining the left side and the right side of the prism 350. Besides, each filter film 314 is a coating layer 380 made on the joint interface between each prism 340 and a prism 350.

Note that the LGE 310 of the present embodiment is formed by a plurality of reflection mirrors and a plurality of filter plates. The reflection mirrors serve as the reflection planes 313, and the filter plates serve as the filter films 314.

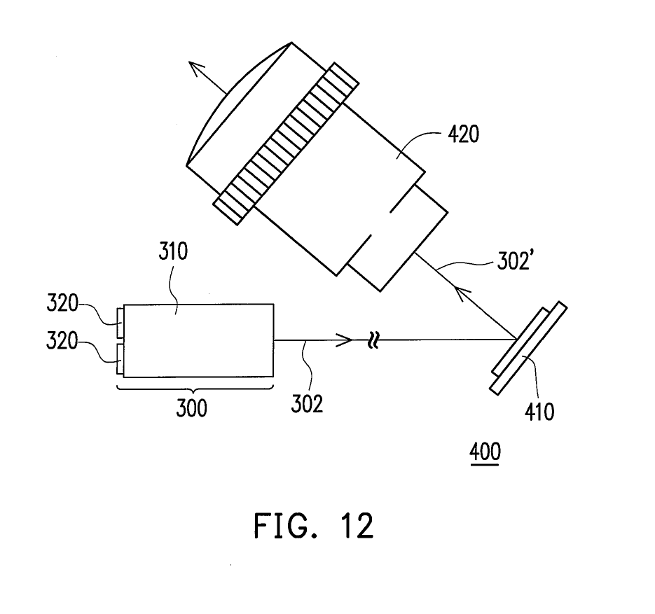

FIG. 12 is a structure diagram of an optical projection apparatus according to an embodiment of the present invention. Referring to FIG. 12, the optical projection apparatus 400 of the embodiment includes a digital micro-mirror device (DMD) 410, a projection lens 420 and the above-described light source module 300 (as shown in FIG. 8). The DMD is disposed on an optical path of a light beam 302 provided by the light source module 300, so as to convert the light beam 302 into an image beam 302′. The projection lens 420 is disposed on an optical path of the image beam 302′, so as to project an image onto a screen (not shown).

Since the light source module 300 according to the present invention has a smaller structure and is able to provide brighter light beam 302, therefore, the optical projection apparatus 400 employing the light source module 300 increases the luminance of the image, without adding the whole volume of the optical projection apparatus 400. Besides, the light source module 300 in the optical projection apparatus 400 of the present embodiment can be replaced by the light source module 200 of the first embodiment (as shown in FIG. 3A).

In summary, the light source module of the present invention has at least the following advantages:

1. Since the light source module of the present invention has a plurality of light source sets, the luminance thereof is advanced. Applying the light source module to an optical projection apparatus, the luminance of the image can be largely increased.

2. The volume of the LGE of the present invention is slightly larger than the volume of the light integration rod in the prior art which uses a single light source set, and the volume of the LGE is obviously smaller than the prior art structure, two light source sets are employed. Apparently, the light source set of the present invention is definitely smaller and compact without adding the whole volume of the optical projection apparatus.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A light source module, comprising:
a light guide element (LGE), having a light exit end, a light incident end and a plurality of reflection planes connected between the light exit end and the light incident end, a first filter film and a second filter film disposed between the edge of the light exit end and the light incident end of the LGE, the internal space of the LGE being divided into a first wedge region located between the first filter film and the light incident end, a second wedge region located between the second filter film and the light incident end and a third wedge region located between the first filter film and the second filter film;
a first light source set, disposed at the light incident end of the LGE and corresponding to the first wedge region; and
a second light source set, disposed at the light incident end of the LGE and corresponding to the second wedge region, wherein the first filter film is suitable for a light beam emitted from the first light source set passing through and reflecting a light beam emitted from the second light source set; the second filter film is suitable for the light beam emitted from the second light source set passing through and reflecting the light beam emitted from the first light source set.

2. The light source module as recited in claim 1, wherein the first light source set comprises a plurality of first color light sources, and the second light source set comprises a plurality of second color light sources and a plurality of third color light sources.

3. The light source module as recited in claim 2, wherein the first color light sources are green light sources, the second color light sources are blue light sources and the third color light sources are red light sources.

4. The light source module as recited in claim 2, wherein the first color light sources, the second color light sources and the third color light sources are light-emitting diodes (LEDs).

5. The light source module as recited in claim 1, wherein the LGE is formed by a first prism corresponding to the first wedge region, a second prism corresponding to the second wedge region, and a third prism corresponding to the third wedge region; the first filter film is a coating layer disposed on the joint interface between the first prism and the third prism, the second filter film is a coating layer disposed on the joint interface between the second prism and the third prism, and the reflection planes are total reflection planes of the first prism, the second prism and the third prism.

6. The light source module as recited in claim 1, wherein the LGE comprises a plurality of reflection mirrors, a first filter plate, and a second filter plate; the reflection mirrors form the reflection planes, the first filter plate is the first filter film and the second filter plate is the second filter film.

7. A light source module, comprising:
a light guide element (LGE), having a light exit end, a light incident end and a plurality of reflection planes connected between the light exit end and the light incident end, a plurality of filter films disposed between the edge of the light exit end and the light incident end of the LGE, the internal space of the LGE being divided into a plurality of taper regions and a common region located between the taper regions; and
a plurality of light source sets, disposed at the light incident end of the LGE and corresponding to the taper regions, wherein each filter film corresponding to the light source set is suitable for a light beam emitted from a corresponding light source set passing through and reflecting light beams emitted from the other different color light source sets.

8. The light source module as recited in claim 7, wherein the light source sets comprise a first color light source set having a plurality of first color light sources, a second color light source set having a plurality of second color light sources, and a third color light source set having a plurality of third color light sources.

9. The light source module as recited in claim 8, wherein the first color light sources are green light sources, the second color light sources are blue light sources and the third color light sources are red light sources.

10. The light source module as recited in claim 9, wherein the first color light sources, the second color light sources and the third color light sources are light-emitting diodes (LEDs).

11. The light source module as recited in claim 7, wherein the LGE is formed by a plurality of prisms corresponding to the taper regions and the common region.

12. The light source module as recited in claim 11, wherein the filter films are coating layers disposed on the prisms, and the reflection planes are total reflection planes of the prisms.

13. The light source module as recited in claim 7, wherein the LGE comprises a plurality of reflection mirrors and a plurality of filter plates, the reflection mirrors form the reflection planes and the filter plates form the filter films.

14. An optical projection apparatus, comprising:
a light guide element (LGE), having a light exit end, a light incident end and a plurality of reflection planes connected between the light exit end and the light incident end, a plurality of filter films disposed between the edge of the light exit end and the light incident end of the LGE, the internal space of the LGE being divided into a plurality of taper regions and a common region located between the taper regions; and
a plurality of light source sets, disposed at the light incident end of the LGE and corresponding to the taper regions, wherein each filter film corresponding to the light source set is suitable for a light beam emitted from a corresponding light source set passing through and reflecting light beams emitted from the other different color light source sets, and afterwards, the light beam emitted from the corresponding light source set is emitted out of the LGE from the light exit end;
a digital micro-mirror device (DMD), disposed on an optical path of the light beam for converting the light beam into an image light beam; and
a projection lens, disposed on an optical path of the image light beam for projecting an image onto a screen.

15. The optical projection apparatus as recited in claim 14, wherein the LGE is formed by a plurality of prisms corresponding to the taper regions and the common region.

16. The optical projection apparatus as recited in claim 14, wherein the LGE comprises a plurality of reflection mirrors and a plurality of filter plates, the reflection mirrors form the reflection planes and the filter plates form the filter films.
